(19) United States
(12) Patent Application Publication
(10) Pub. No.: US 2026/0309201 A1
(43) Pub. Date: Oct. 8, 2026

(54) DOOR GLASS VIBRATION-DAMPING STRUCTURE AND VIBRATION-DAMPING STABILIZER

(71) Applicant: KINUGAWA RUBBER IND. CO., LTD., Chiba-shi (JP)

(72) Inventors: Yuuji SATOU, Chiba-shi, Chiba (JP); Shouya YAJIMA, Chiba-shi (JP)

(73) Assignee: KINUGAWA RUBBER IND. CO., LTD., Chiba-shi (JP)

(21) Appl. No.: 19/539,153

(22) Filed: Feb. 13, 2026

(30) Foreign Application Priority Data
Feb. 14, 2025 (JP) 2025-022188

(51) Int. Cl. F16F 7/12

(52) U.S. Cl. CPC F16F 7/128

(57) ABSTRACT

[OBJECT] An object of the present invention is to provide a door glass vibration-damping structure and a vibration-damping stabilizer that suppress an increase in mass and suppress resonance of a door glass at low cost, and improve sound insulation properties and raising/lowering capability.

[SOLUTION] A vibration-damping stabilizer 1 includes a holding member 11 and an elastic member 12. The holding member 11 is attached to a door glass 3. The elastic member 12 is interposed between the door glass 3 and the holding member 11. A loss factor tan δ of the elastic member 12 is 0.3 or more.

### TECHNICAL FIELD

The present invention relates to a door glass vibration-damping structure and a vibration-damping stabilizer for an automobile.

### BACKGROUND ART

For a door glass for an automobile, tempered glass of 3 to 5 mm is generally used (Patent Document 1, etc.). In thin and hard glass, a coincidence phenomenon occurs due to resonance between a natural frequency (an eigenfrequency) and incident sound. Since a coincidence frequency varies depending on the plate thickness of the glass, assuming the plate thickness, the coincidence frequency occurs in a frequency band of about 2000 to 4000 Hz where auditory sensitivity is high, and lowers transmission loss of the glass, which becomes one of the causes of vehicle interior noise.

Therefore, in order to compensate for a decrease in transmission loss due to coincidence, a door glass structure in which a glass plate is thickened to improve sound insulation properties based on the mass law has been proposed (Patent Document 2). Further, in order to suppress the coincidence frequency (resonance), a door glass structure in which sound insulation is achieved by laminating thin glass via a resin film has been proposed (Patent Document 3).

### CITATION LIST

### Patent Document

[Patent Document 1] Japanese Unexamined Patent Application Publication No. 2023-105940
[Patent Document 2] Japanese Unexamined Patent Application Publication No. 2023-000975
[Patent Document 3] Japanese Unexamined Patent Application Publication No. 2002-321526

### SUMMARY OF THE INVENTION

### Technical Problem

However, a door glass structure in which a glass plate is thickened as in Patent Document 2 results in an increase in mass. Furthermore, a glass vibration-damping structure in which a resin film is interposed as in Patent Document 3 increases manufacturing costs. In addition, since the rigidity of the glass itself is low, when the glass is raised and lowered during high-speed driving, a displacement sucked out due to a pressure difference between the inside and outside of the vehicle interior increases, which may deteriorate the raising/lowering capability of the door glass.

The present invention was made in view of the above circumstances, and an object of the present invention is to provide a door glass vibration-damping structure and a vibration-damping stabilizer that suppress an increase in mass and suppress resonance of a door glass at low cost, and improve sound insulation properties and raising/lowering capability.

### Solution to Problem

one aspect of the present invention comprises: a vibration-damping member attached to a door glass; and an elastic member interposed between the door glass and the vibration-damping member. A loss factor tan δ of the elastic member is 0.3 or more.

### Effects of Invention

According to the present invention described above, it is possible to provide a door glass vibration-damping structure and a vibration-damping stabilizer that suppress an increase in mass and suppress resonance of a door glass at low cost, and improve sound insulation properties and raising/lowering capability.

### BRIEF DESCRIPTION OF THE DRAWINGS

FIG. 1 is an A-A cross-sectional view of FIG. 9 showing a door of an automobile provided with a vibration-damping stabilizer according to an embodiment 1 of the present invention.

FIG. 2 shows plan views of a door glass, illustrating mounting positions of the vibration-damping stabilizer of FIG. 1.

FIG. 3 shows examples of Chladni figures of a glass plate based on various vibration frequencies.

FIG. 4 is a diagram showing a relationship between a spring constant and an amount of strain.

FIG. 5 is a characteristic diagram showing a relationship between loss factors tan δ of various elastic materials and temperature.

FIG. 6 shows (a) a plan view of a door of an automobile provided with a vibration-damping stabilizer according to an embodiment 2 of the present invention, and (b) an enlarged plan view of the vibration-damping stabilizer.

FIG. 7 shows (a) a cross-sectional view of an aspect example 1 of the vibration-damping stabilizer of the embodiment 2, and (b) a cross-sectional view of an aspect example 2 of the vibration-damping stabilizer.

FIG. 8 shows (a) a cross-sectional view of an aspect example 3 of the vibration-damping stabilizer of the embodiment 2, and (b) a cross-sectional view of an aspect example 4 of the vibration-damping stabilizer.

FIG. 9 is a front view of a door to which the vibration-damping stabilizer of the present invention is applied.

### EMBODIMENTS FOR CARRYING OUT THE INVENTION

Embodiments of the present invention will be described below with reference to the drawings.

### Embodiment 1

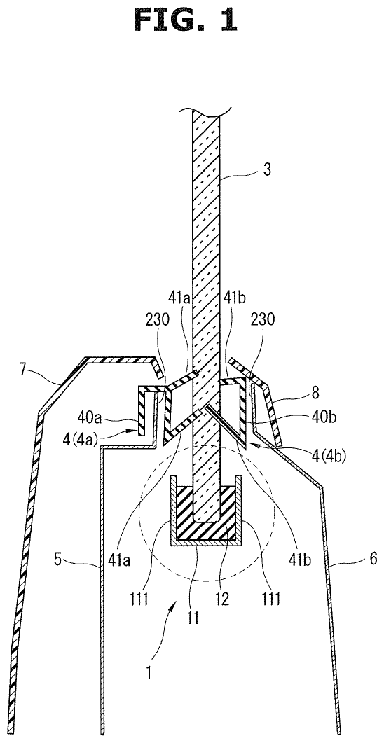

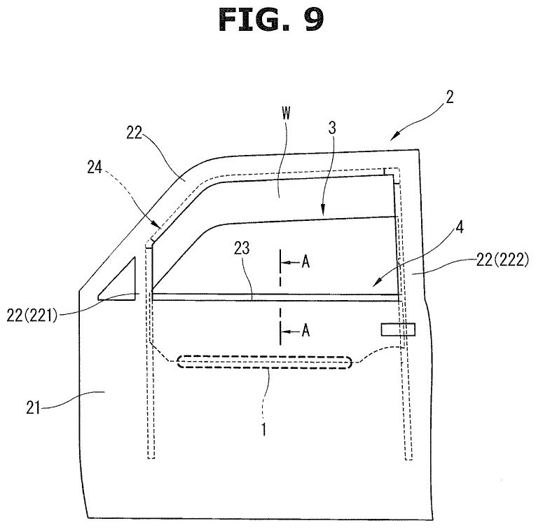

A vibration-damping stabilizer 1 of an embodiment 1, which is one aspect of the door glass vibration-damping structure of the present invention shown in FIG. 1, is applied to a door glass 3 of a door 2 of an automobile illustrated in FIG. 9.

The door 2 includes a door body 21, and a door sash 22 extending upward in an arch shape from a door waist portion 23 of the door body 21. A glass opening W is formed between the door body 21 and the door sash 22, and a glass run 24 is attached to a peripheral edge portion of the glass opening W.

As shown in FIG. 1, the door glass 3 is disposed so as to be able to come out from and come into a door waist opening portion 230 opening above the door waist portion 23, and so as to be able to move up and down along vertical side portions 221 and 222 of the door sash 22 shown in FIG. 9. This door glass 3 can be raised and lowered (move up and down) by a window regulator (not shown) mounted inside the door body 21.

At the door waist portion 23 of the door body 21, a vehicle-interior-side waist seal 4a and a vehicle-exterior-side waist seal 4b are arranged as a pair of waist seals 4.

The vehicle-interior-side waist seal 4a is mounted on an upper edge portion of a door inner panel 5 covered by a door trim 7, and seals a gap between the door glass 3 and the door inner panel 5. The vehicle-interior-side waist seal 4a includes a mounting base portion 40a used for mounting the vehicle-interior-side waist seal 4a to the door inner panel 5, and a pair of upper and lower seal lips 41a projecting substantially parallel to each other from the mounting base portion 40a and capable of coming into elastic contact with the door glass 3.

The vehicle-exterior-side waist seal 4b is disposed along an upper edge portion of a door outer panel 6 covered by a belt molding 8, and seals a gap between the door glass 3 and the door outer panel 6. The vehicle-exterior-side waist seal 4b includes a mounting base portion 40b used for mounting the vehicle-exterior-side waist seal 4b to the door outer panel 6, and a pair of upper and lower seal lips 41b projecting substantially parallel to each other from the mounting base portion 40b and capable of coming into elastic contact with the door glass 3.

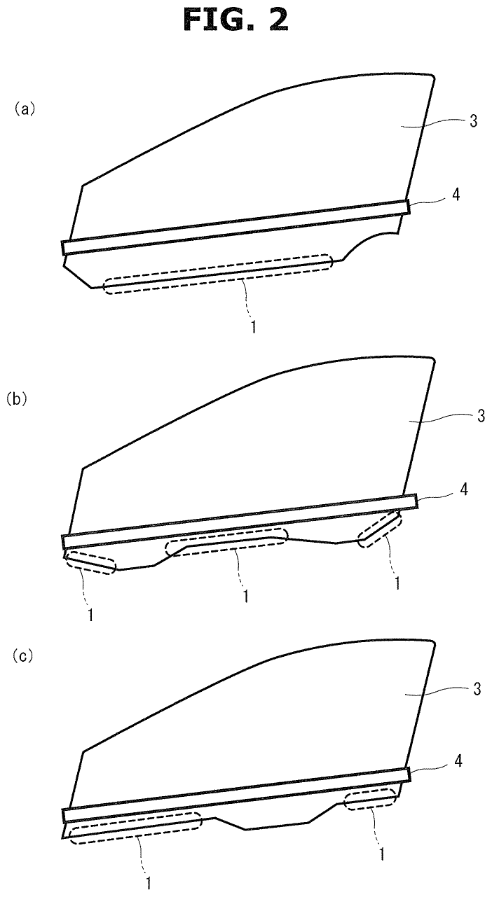

As shown in FIG. 2, one or a plurality of vibration-damping stabilizers 1 are provided for the door glass 3 at a portion on a lower end side of the door glass 3.

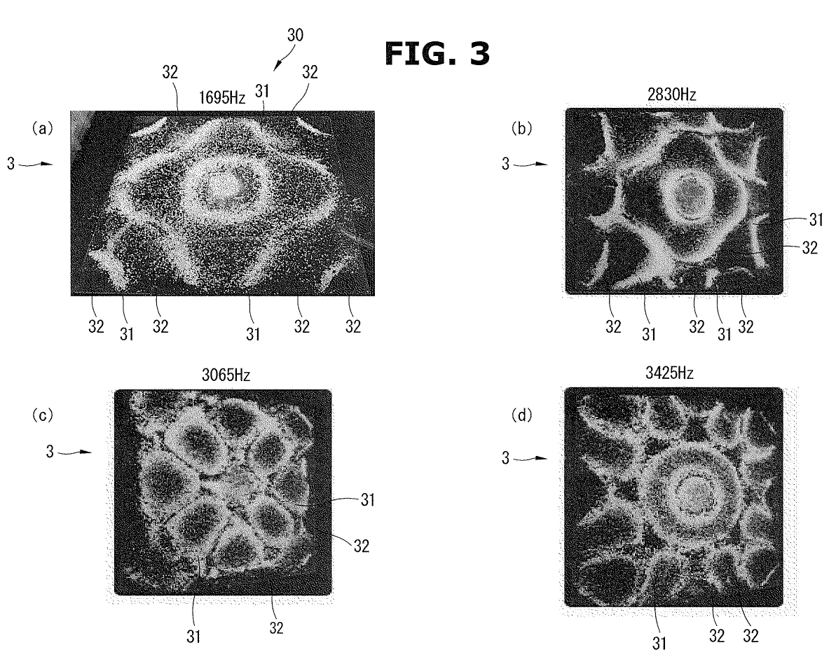

As shown in FIGS. 1 and 3, the vibration-damping stabilizer 1 includes a holding member 11 as a vibration-damping member attached to the door glass 3. The holding member 11 holds the door glass 3 via an elastic member 12.

A glass plate has a natural frequency (an eigenfrequency) called a coincidence frequency. Although the coincidence frequency of a glass plate varies depending on the thickness of the glass plate, it is generated by surface vibration of 2000 Hz or more and 4000 Hz or less.

A wave of surface vibration of a glass plate can be represented by Chladni FIG. 30 having different rules depending on frequency, plate thickness, and side length (shape) as illustrated in FIG. 3. The Chladni FIG. 30 visualizes nodes 31 (boundaries of surface vibration) of the natural vibration (the eigenfrequency) of the glass plate. In the Chladni FIG. 30, a portion where vibration is small and powder is concentrated is referred to as the node 31, and a portion where vibration is large and a little powder exists is referred to as an antinode 32.

FIG. 3 shows examples of the Chladni FIG. 30 of a glass plate. When a glass plate having a vertical length of 300 mm and a horizontal length of 300 mm, and a plate thickness of 4.0 mm is vibrated by a sweep sound of a vibration speaker at 2 kHz to 3 kHz, Chladni figures having different shapes are observed under a coincidence frequency of 1 kHz to 4 kHz. (a), (b), (c), and (d) in the figure are Chladni figures obtained under coincidence frequencies of 1695 Hz, 2830 Hz, 3065 Hz, and 3425 Hz, respectively.

In order to attenuate vibration of the door glass 3, it is necessary to efficiently transmit the vibration to the vibration-damping stabilizer 1. Since the node 31 of the Chladni FIG. 30 has small vibration, by mounting the vibration-damping stabilizer 1 at a portion including the antinode(s) 32, vibration of the door glass 3 can be efficiently transmitted to the elastic member 12 of the vibration-damping stabilizer 1.

Since the door glass 3 for the automobile does not have a simple shape, it is difficult to predict the Chladni figure. Therefore, the mounting position of the vibration-damping stabilizer 1 is determined based on the Chladni FIG. 30 obtained in advance by a vibration experiment.

As shown in FIG. 1, the holding member 11 is made of a channel-shaped steel plate capable of holding a portion on the lower end side of the door glass 3 via the elastic member 12. As the steel material, it is well-known rust-proof steel materials exemplified by hot-dip plated steel plates and the like, but in order to apply a preload (a holding force) to the elastic member 12, a well-known spring steel plate exemplified by SUS304-CSP or the like is applied.

When the spring steel plate is applied, a size in a length direction of the holding member 11 is set to a minimum in order to fixedly retain the elastic member 12 and suppress a mounting space and mass of the vibration-damping stabilizer 1.

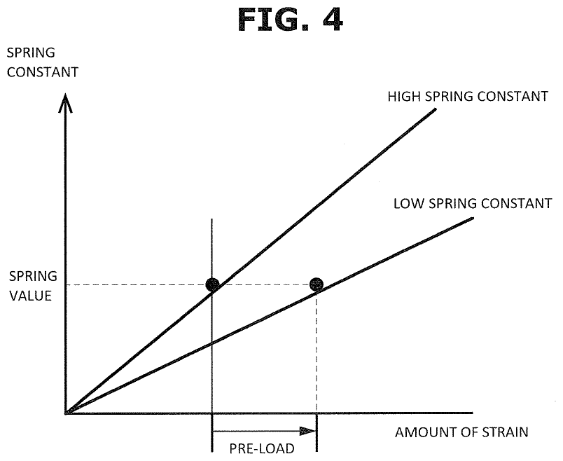

Furthermore, in order to efficiently transmit vibration of the door glass 3 to the elastic member 12, a spring constant of the holding member 11 is appropriately adjusted to be high. In order to adjust the spring constant to be high, for instance, convex portions (not shown) that curve toward the inside of the holding member 11 are formed on a pair of side surface portions 111 of the holding member 11. From the relationship between the spring constant and the amount of strain shown in FIG. 4, the elastic member 12 having a low spring constant is contracted by being held (sandwiched or pinched) by the holding member 11 having a high spring constant, and is brought into a state in which a pre-load is applied to the elastic member 12 from the holding member 11 (a state in which a load is applied in advance), thereby obtaining a spring constant equivalent to that of the holding member 11. In this way, the holding member 11 holds the door glass 3 in the state in which the spring constant of the elastic member 12 is previously increased, thereby transmitting vibration of the door glass 3 to the elastic member 12.

The elastic member 12 is not particularly limited as long as a loss factor tan δ of 0.3 or more can be secured, and well-known rubber materials and synthetic resin materials are applied (for instance, Patent Documents 1 to 3). The loss factor tan δ indicates a ratio between a loss elastic modulus and a storage elastic modulus of the elastic member. The loss elastic modulus indicates a characteristic of viscosity (stickiness, difficulty in returning) of the elastic member. The larger the viscosity, the larger the energy loss. The storage elastic modulus indicates a characteristic of elasticity (property of bouncing back) of the elastic member.

As the rubber materials, they are butyl rubber, butadiene rubber, ethylene propylene diene rubber, isoprene rubber, chloroprene rubber, nitrile rubber, neoprene rubber, acrylic rubber, urethane rubber, silicone rubber, fluororubber, and the like. As the synthetic resin materials, they are thermoplastic elastomers exemplified by polyester resins, acrylic resins, urethane resins, vinyl chloride resins, styrene resins, and the like.

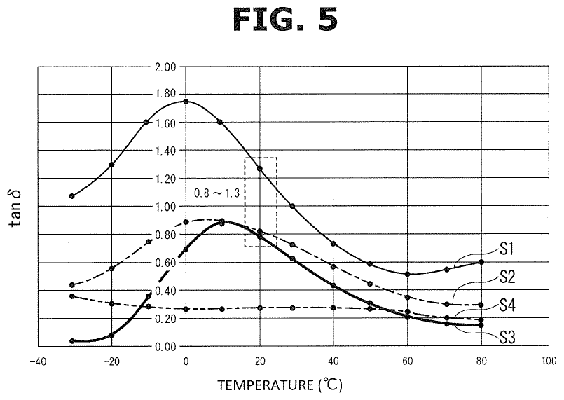

FIG. 5 shows a relationship between loss factors tan δ of various elastic materials (samples S1 to S4) and temperature. Sample S1 is a non-PVC resin (whose main ingredients are mica and polyester resin). Sample S2 is butyl rubber. Sample S3 is a styrene resin. Sample S4 is ethylene propylene diene rubber.

An elastic material tends to have higher vibration-damping properties as the loss factor tan δ is higher, while having a lower spring constant (lower hardness) as the loss factor tan δ is higher. From the results in the figure, in particular, by applying samples S1 to S3, whose loss factors tan δ are 0.8 or more and 1.3 or less under normal temperature (room temperature) (20 to 35° C.), to the elastic member 12, it is possible to achieve improvement in vibration-damping properties while suppressing a decrease in the spring constant of the vibration-damping stabilizer 1.

When a total mass of the holding member 11 and the elastic member 12 is adjusted to be 5% or more and 15% or less of a mass of the door glass 3, the vibration-damping stabilizer 1 described above can achieve both size reduction of the vibration-damping stabilizer 1 and weight reduction of the automobile.

Working and effects of the vibration-damping stabilizer 1 of the present embodiment will be described with reference to FIGS. 1 to 5.

Vibration-damping stabilizers for the door glass 3 of the automobile include an unconstrained type and a constrained type, and the constrained type can obtain a higher vibration-damping effect. According to the vibration-damping stabilizer 1 of the present embodiment, the door glass 3 is constrained by being held by the holding member 11 via the elastic member 12 of the vibration-damping stabilizer 1.

In the case of surface vibration of the door glass 3, as illustrated in FIG. 3, a wave due to vibration propagation appears as the Chladni FIG. 30 according to shape factors such as a plate thickness and each side length of the door glass 3, and frequency. Since the antinode 32 of the Chladni FIG. 30 vibrates most, by setting the vibration-damping stabilizer 1 at a portion including the antinode(s) 32, the surface vibration can be transmitted to the elastic member 12, and efficient vibration-damping becomes possible. It has been experimentally confirmed that generation of the Chladni FIG. 30 is suppressed.

Vibration isolation and vibration damping by the elastic member 12 are different approaches. The vibration damping reduces vibration energy (attenuation) by converting energy into heat or the like and consuming it by a material having a high loss factor tan δ and constituting the elastic member 12. On the other hand, the vibration isolation prevents resonance (does not attenuate vibration) by shifting a frequency by changing a natural frequency (an eigenfrequency) through mass and a spring constant (rigidity). A material having a high loss factor tan δ generally has high viscosity and a low spring constant. The vibration-damping stabilizer 1 is aimed at attenuating vibration, and has a high loss factor tan δ. As described above, since the vibration isolation and the vibration damping are trade-off characteristics, it is not possible to improve both at the same time.

In the vibration-damping stabilizer 1 of the present embodiment, an attenuation effect is enhanced by adjusting the loss factor tan δ of the elastic member 12 to 0.3 or more. In particular, as shown in FIG. 5, by adjusting the loss factor tan δ to 0.8 or more and 1.3 or less, a good attenuation effect of 12 to 19 dB is obtained against surface vibration of 3500 Hz under normal temperature (room temperature) while suppressing a decrease in spring constant, and both vibration isolation and vibration damping can be achieved.

Furthermore, the vibration-damping stabilizer 1 is required to be downsized and minimized in mass from the viewpoints of minimizing a mounting space and reducing weight of an automobile. In addition, in order to efficiently transmit surface vibration of the door glass 3 to the elastic member 12 of the vibration-damping stabilizer 1, it is necessary to increase a spring constant (rigidity) of the holding member 11.

In the vibration-damping stabilizer 1, by applying a channel-shaped spring steel plate to the holding member 11 capable of holding the door glass 3 via the elastic member 12, a pre-load (a holding force) of the holding member 11 increases, and a spring constant improves. Then, by applying this increased pre-load to the elastic member 12, surface vibration of the door glass 3 is efficiently transmitted. Therefore, improvement in rigidity, downsizing, and minimization of mass of the vibration-damping stabilizer 1 are realized.

As described above, according to the vibration-damping stabilizer 1 of the present embodiment, it is possible to suppress an increase in mass and suppress resonance of a door glass at low cost, and improve sound insulation properties and raising/lowering capability.

### Embodiment 2

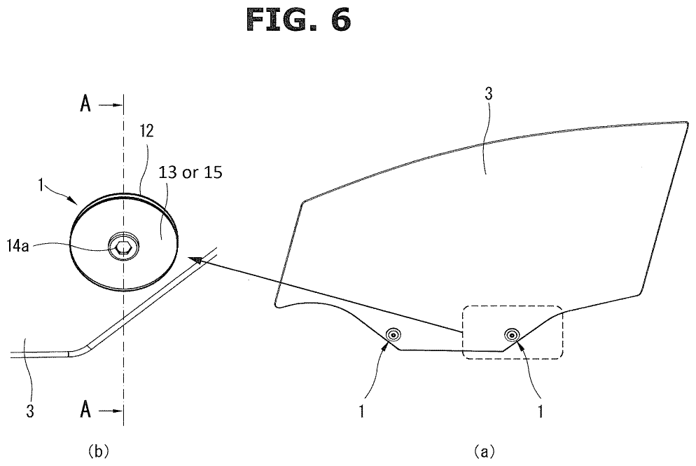

The vibration-damping stabilizer 1 of the present invention can also take an aspect of the vibration-damping stabilizer 1 of an embodiment 2 shown in FIG. 6. Concrete aspect examples of the embodiment 2 will be described below.

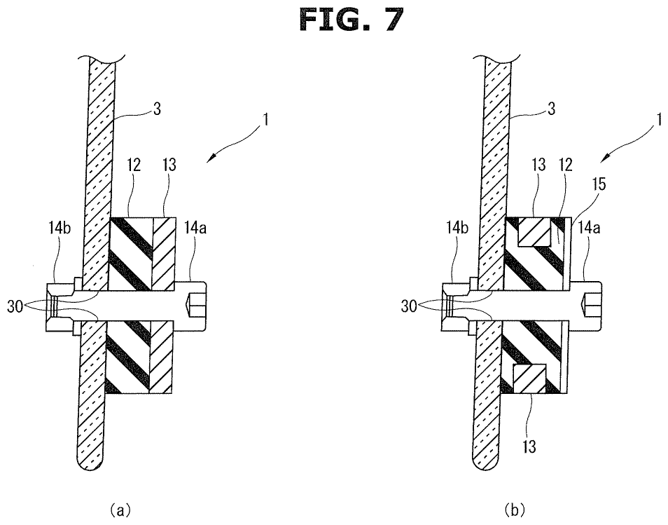

In the vibration-damping stabilizer 1 of FIG. 7, a weight 13 or a washer 15 as the vibration-damping member is attached to a portion on the lower end side of the door glass 3 via the elastic member 12.

In the aspect example 1 of FIG. 7(a), the elastic member 12 and the weight 13 have a washer shape. The elastic member 12 is interposed between the door glass 3 and the weight 13. The weight 13 is made of, for instance, a steel material equivalent to the holding member 11 of the embodiment 1. A nut 14b is screwed onto a bolt 14a inserted through fixing holes 33 of the weight 13, the elastic member 12, and the door glass 3, then, the weight 13 is fixed to the portion of the door glass 3 via the elastic member 12. The elastic member 12 may be integrally molded (vulcanization-bonded) with the weight 13.

In the aspect example 2 of FIG. 7(b), the elastic member 12 has a grommet shape to which a ring-shaped weight 13 is attached, and is interposed between the door glass 3 and a washer 15. Similar to the weight 13, the washer 15 is made of, for instance, a steel material equivalent to the holding member 11 of the embodiment 1. A nut 14b is screwed onto a bolt 14a inserted through fixing holes 33 of the washer 15, the elastic member 12, and the door glass 3, then, the weight 13 is fixed to the portion of the door glass 3 via the elastic member 12.

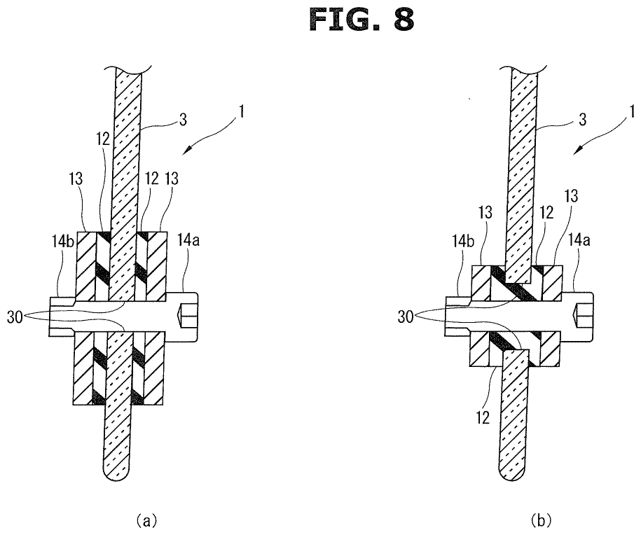

In the vibration-damping stabilizer 1 of FIG. 8, weights 13 are installed at a portion on the lower end side of the door glass 3, as the vibration-damping member fixed at a portion including the antinode(s) 32 of the Chladni FIG. 30 on both surfaces of the door glass 3, via the elastic members 12 with the fasteners.

In the aspect example 3 of FIG. 8(a), the elastic members 12 also have a washer shape, and are interposed between the door glass 3 and the respective weights 13. A nut 14b is screwed onto a bolt 14a inserted through fixing holes 33 of the weights 13, the elastic members 12, and the door glass 3, then, the weights 13 are fixed to the portion of the door glass 3 via the elastic members 12.

In the aspect example 4 of FIG. 8(b), the elastic member 12 has a grommet shape mounted in a fixing hole 33 of the door glass 3. The weights 13 have a washer shape. A nut 14b is screwed onto a bolt 14a inserted through the weights 13 and the elastic member 12, then, the weights 13 are fixed to the portion of the door glass 3 via the elastic members 12.

According to the vibration-damping stabilizer 1 of the embodiment 2 described above, it is clear that the same effects as those of the vibration-damping stabilizer 1 of the embodiment 1 can be obtained.

In particular, according to the embodiment 2, a plurality of the vibration-damping stabilizers 1 can be arbitrarily set at portions on the lower end side of the door glass 3 according to the number of portions including the antinode(s) 32 of the Chladni FIG. 30. Furthermore, a pre-load can be arbitrarily applied to the elastic member 12 by adjusting masses and rigidities of the weight 13, the fastener (the bolt 14a, the nut 14b), and the washer 15, and a fastening force of the fastener. Therefore, resonance of the door glass 3 can be arbitrarily suppressed, and sound insulation properties and raising/lowering capability of the door glass 3 can be further improved.

### DESCRIPTION OF REFERENCE SYMBOLS

1 . . . vibration-damping stabilizer, 11 . . . holding member, 12 . . . elastic member, 13 . . . weight, 14a . . . bolt, 14b . . . nut, 15 . . . washer
2 . . . door
3 . . . door glass, 30 . . . Chladni figure, 31 . . . node,
32 . . . antinode

1. A door glass vibration-damping structure comprising:
a vibration-damping member attached to a door glass; and
an elastic member interposed between the door glass and the vibration-damping member,
wherein a loss factor tan δ of the elastic member is 0.3 or more.

2. The door glass vibration-damping structure as claimed in claim 1, wherein
a coincidence frequency of the door glass, at which a Chladni figure is formed in the door glass, is 2000 Hz or more and 4000 Hz or less.

3. The door glass vibration-damping structure as claimed in claim 1, wherein
the loss factor tan δ of the elastic member is 0.5 or more and 1.3 or less.

4. The door glass vibration-damping structure as claimed in claim 1, wherein
the vibration-damping member is made of a channel-shaped spring steel plate that holds the door glass via the elastic member.

5. The door glass vibration-damping structure as claimed in claim 1, wherein
the vibration-damping member is made of a ring-shaped or washer-shaped steel plate that is fixed to the door glass via the elastic member.

6. The door glass vibration-damping structure as claimed in claim 1, wherein
a total mass of the vibration-damping member and the elastic member is 5% or more and 15% or less of a mass of the door glass.

7. A vibration-damping stabilizer comprising
the door glass vibration-damping structure according to claim 1.
